(19) United States
(12) Patent Application Publication
(10) Pub. No.: US 2022/0339813 A1
(43) Pub. Date: Oct. 27, 2022

(54) FOOD PRODUCT SLICER WITH GAUGE PLATE POSITION IDENTIFICATION

(71) Applicant: ILLINOIS TOOL WORKS INC., Glenview, IL (US)

(72) Inventor: Matthew W. BIRD, Fairborn, OH (US)

(21) Appl. No.: 17/720,495

(22) Filed: Apr. 14, 2022

Related U.S. Application Data
(60) Provisional application No. 63/179,596, filed on Apr. 26, 2021.

(51) Int. Cl. B26D 7/01; B26D 1/143; B26D 7/30; B26D 7/06

(52) U.S. Cl. CPC B26D 7/01; B26D 1/143; B26D 7/30; B26D 7/0616; B26D 2210/02

(57) ABSTRACT

A food product slicer includes a base, a knife mounted for rotation relative to the base, a carriage assembly mounted to the base for reciprocal movement back and forth past a cutting edge of the knife, and an adjustable gauge plate mounted for movement between a closed position that prevents slicing and multiple open positions that permit slicing at respective thicknesses. A slice thickness identification system includes: at least one sensor for determining a position of the gauge plate; and a display for displaying a slice thickness indicator corresponding to the determined position.

### TECHNICAL FIELD

This application relates generally to food product slicers of the type commonly used to slice bulk food products and, more specifically, to a gauge plate system in such a food product slicer.

### BACKGROUND

Typical reciprocating food slicers have a rotatable, circular or disc-like slicing blade, an adjustable gauge plate for determining the thickness of the slice and a carriage for supporting the food as it is moved back and forth past the cutting edge of the knife during slicing. A drive motor is typically linked to drive the carriage back and forth during an automatic slicing operation carried out by a controller of the slicer. The gauge plate is situated along the edge of the knife toward the front of a slicing stroke and is laterally movable with respect to the knife for determining the thickness of the slices to be cut. A rotatable adjustment knob is provided manually for setting a spacing between the plane of the gauge plate surface and the plane of the knife edge for the purpose of slicing so that operators can select a thickness of slices to be produced. Existing slicers generally utilize a pin/cam mechanism to translate the rotational motion of the knob into the linear motion of a gauge plate. Moving the gauge plate away from a slicer knife is what allows the operator to choose the slice thickness. Movement of the gauge plate is generally a linear movement of the plane of the gauge plate relative to the plane of the knife edge. The gauge plate has a “closed” position in which the position of the gauge plate is such that slices will not be cut even if the carriage and associated food product are moved back and forth past the knife. When the gauge plate is “open” a range of positions provide for slices of varying thickness.

In prior slicers with the pin/cam mechanism, the cam spiral is generally an exponential spiral (as opposed to a linear spiral), and thus the radial position of the knob does not correspond to an intuitive linear position of the gauge plate. Further, since the knob usually makes more than 1 full rotation, the knob index must be relative. There is a considerable amount of inconvenience built into this design. Operator's must spend time and may waste product adjusting the slice thickness. One of the biggest issues with the current pin/cam designs is the inconsistency that is produced not only between individual machines but also between slicing sessions of one machine. Backlash, relative indexing, and machine-specific alignment often force the operator to rely on subjective interpretation in an attempt to achieve consistent slice thickness.

Accordingly, it would be desirable to address one or more of the above-noted issues.

### SUMMARY

In one aspect, a food product slicer includes a base, a knife mounted for rotation relative to the base, a carriage assembly mounted to the base for reciprocal movement back and forth past a cutting edge of the knife and an adjustable gauge plate mounted for movement between a closed position that prevents slicing and multiple open positions that permit slicing at respective thicknesses. A slice thickness identification system includes at least one sensor for determining a position of the gauge plate, and a display for displaying a slice thickness indicator corresponding to the determined position.

In another aspect, a food product slicer includes a base, a knife mounted for rotation relative to the base, a carriage assembly mounted to the base for reciprocal movement back and forth past a cutting edge of the knife and an adjustable gauge plate mounted for movement between a closed position that prevents slicing and multiple open positions that permit slicing at respective thicknesses. A gauge plate drive system includes a motor for adjusting the gauge plate position and a controller configured to drive the motor responsive to operator selection of a thickness.

### BRIEF DESCRIPTION OF DRAWINGS

FIG. 1 is a perspective view of a slicer;

FIG. 2 is a side elevation of the slicer;

FIG. 3 is a perspective view of a gauge plate system;

FIG. 4 is a schematic depiction of a control system; and

FIG. 5 is a perspective view of a gauge plate system including a motor.

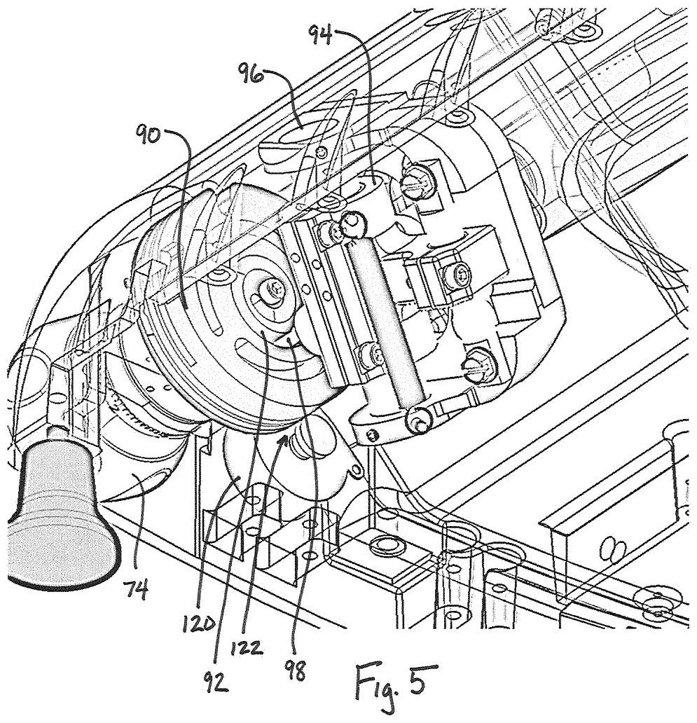

### DETAILED DESCRIPTION

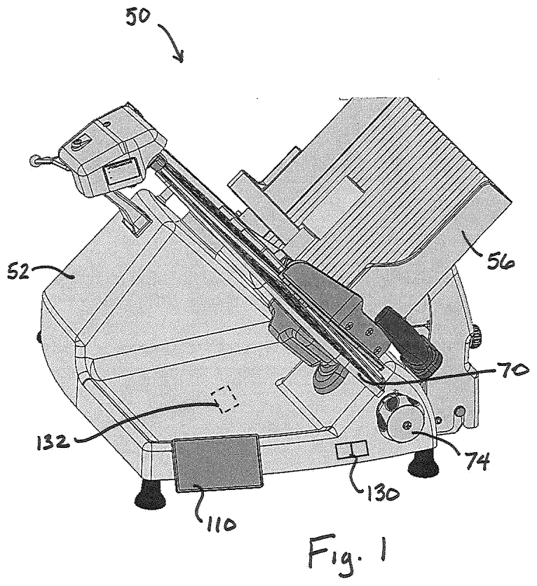

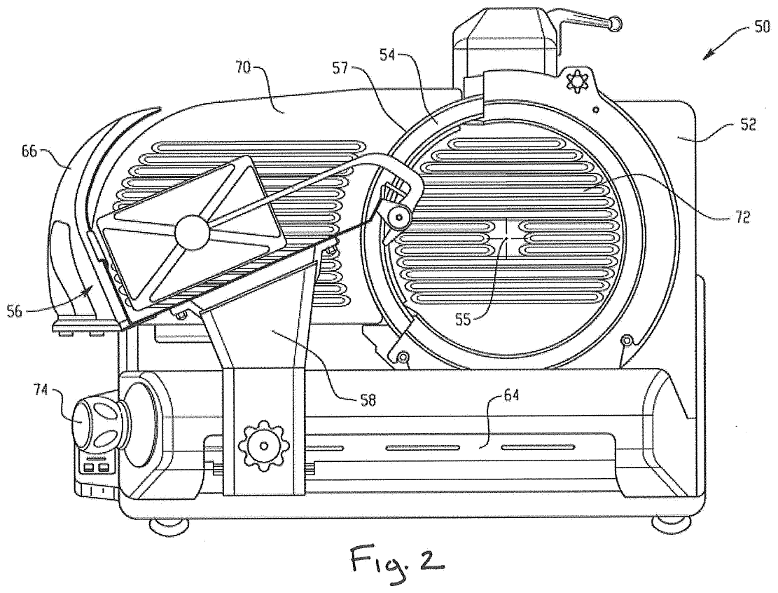

Referring to FIGS. 1-2, a food product slicer 50 includes a housing or base 52 and a circular, motor-driven slicing knife 54 that is mounted to the housing for rotation about an axis 55. The left side of FIG. 2, where the controls are located, is generally referred to as the front side of the slicer (which is where an operator stands for slicing), the right side of FIG. 2 is generally referred to as the rear side of the slicer and FIG. 2 depicts a right side view of the slicer. A food product can be supported on a manually operable (or motor driven) food carriage 56 which moves the food product to be sliced past the cutting edge 57 of the rotating slicing knife 54. The food carriage 56 reciprocates from left to right relative to FIG. 2, along a linear path so that the lower end of the bulk food product slides along the surface of the gauge plate 70, is cut by the knife 54 and then slides along a knife cover plate 72. Food carriage 56 includes a tray mounted on a tray arm 58 that orients the food carriage tray at the appropriate angle (typically perpendicular) to the cutting edge plane. The food carriage reciprocates in a slot 64 at a lower portion of the housing 52 and a handle 66 is mounted to the food carriage 56. The handle is graspable by a user and can be used to manually move the food carriage. The carriage may also be automatically driven (e.g., as by a motor 67). A handle or knob 74 for adjusting the gauge plate to control slice thickness is also shown.

Repeatability of slice thickness is the control of slice thickness within a similar product, for example, if a particular machine slices ham at index setting of 4, on the adjustment knob, and that thickness is desirable, the next time a customer comes back to have more ham sliced and that if the index is set on 4 it will cut the same thickness. This theory will also apply from machine to machine repeatability. Prior techniques provided repeatability within a certain degree but not as consistent as desired. The machine to machine repeatability was generally not present.

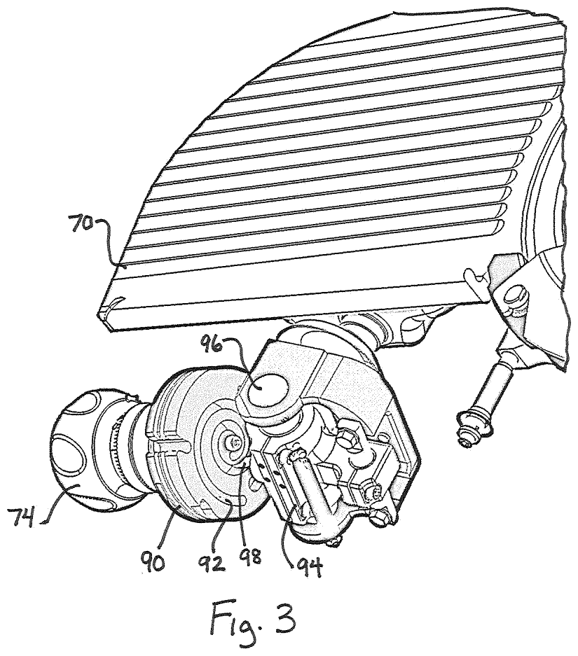

Referring to FIG. 3, a gauge plate system includes a rotatable handle assembly with a handle 74 that rotates a cam 90 with a spiral cam slot 92. The gauge plate 70 is mounted such that adjustment of the slice thickness is achieved by movement of a slider 94 of the gauge plate mount assembly along a shaft 96. The slider 94 includes an associated pin 98 that rides in the spiral cam slot 92 for this purpose.

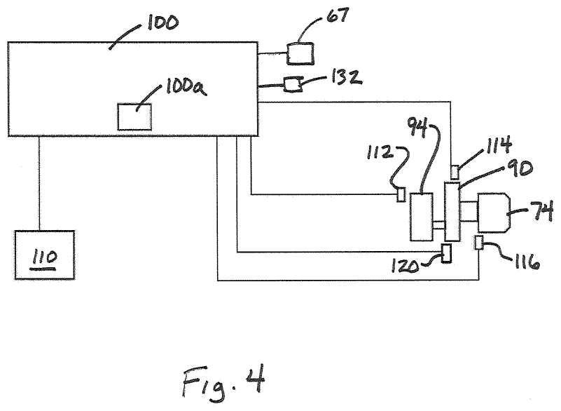

Referring to FIG. 4, a schematic depiction of a slicer with a gauge plate thickness control is provided. A display 110 provides a digital readout of the actual gauge plate position. This will give a precise measurement for the slice thickness that is repeatable (even if there is no stepper motor being used to move the gauge plate). The display 110 could, in one embodiment, be a touch-screen display used as a user-interface. In other embodiments, the display 110 could be a display device that only functions to output the gauge plate position information.

One exemplary technique of identifying slice thickness based upon position of the gauge plate is to utilize a capacitive array 112 to detect motion/position. As the slider 94 moves, AC voltages are picked up and interpolated to determine position (e.g., with 0.0002″ accuracy over ˜6 inches). This technique involves a need for zeroing because the capacitive array 112 provides a relative measurement. Zeroing can occur upon slicer power-up automatically or every time the gauge plate is closed completely, as indicated by a gauge plate closed switch 114 tripping to rezero the measuring device. Linear or rotational embodiments are contemplated.

Another technique of measurement or determination of slice thickness based upon position of the gauge plate is to use an encoder 116. By way of example, an encoder uses a light source and a photodetection device is provided and a disk passes between the light source and light sensor. This disk is “coded” in such a way that provides the software (e.g., in a controller 100) enough information to determine where the disk is rotationally. If the controller 100 knows the rotational position of the indexing cam 90, the controller 100 can interpolate where the gauge plate is (e.g., known points could be stored in memory to match rotational data points of the indexing cam with the corresponding linear data points of the gauge plate). Linear or rotational embodiments are contemplated.

A small stepper motor 120 could be provided for powered rotation of the knob 74, and thus powered positioning of the gauge plate. In such an embodiment, the gauge plate system can be designed so that there are two possible inputs: (i) the stepper motor 120 can control the gauge plate position or (ii) the operator can manually rotate the knob 74 to control gauge plate position. The stepper motor 120 may include a geared connection 122 to the cam 90 for effecting the powered cam movement. In this embodiment, and encoder internal of the stepper motor could be used for monitoring position of the cam 90, and thus position of the gauge plate.

The controller 100 can include memory 100a and a stored memory function for one or more high-use thicknesses, which are stored and selected by the operator to quickly and accurately achieve the same slice thickness repeatedly, with the controller 100 responsively driving the stepper motor 120 in accordance with the selection.

A standard practice for slicing a chunk of meat is to cut off a large unusable section of the chub before slicing. The slicer controller 100 can be programmed to initially drive the stepper motor 120 to move the gauge plate to automatically cut this first section off at a predetermined thickness and then, for the purpose of the next slices, immediately drive the stepper motor 120 to move the gauge plate to a position to achieve a different selected/desired slice thickness without stopping and without operator input. In one operating mode, the controller 100 of the food product slicer 50 stores in the memory a first section thickness, and the controller 100 is configured to drive the motor 120 to the first section thickness for a first slice then adjust the motor 120 to another predetermined thickness, which typically would be less than the first thickness, for the subsequent slices. In embodiments, this operating mode may be selected and/or may be selectively enabled and disabled as desired via the user interface (e.g., touch-screen display 110).

In combination with a scale, the controller 100 could be configured to automatically adjust slice thickness to achieve and maintain a desired weight per slice. It is often difficult to maintain an exact weight for each slice as most chunks of meat vary in cross sectional area, and for some applications this featured would be desirable. By way of example, the controller could be configured with a thickness adjust feature to adjust gauge plate position to achieve a relatively uniform slice weight (e.g., if the incremental weight of each slice drops below a set range, the gauge plate could be driven to further open until the incremental slice weight comes back in range or if the incremental weight of each slice rises above a set range the gauge plate could be driven to close slightly until the incremental slice weight comes back into range).

It is to be clearly understood that the above description is intended by way of illustration and example only and is not intended to be taken by way of limitation. Variations are possible.

For example, various types of sensors could be used for determining the position of the gauge plate, such as a linear potentiometer, and infrared distance sensor, or an imaging system sensor (e.g., camera). In any such case, the sensor may sense the position of the gauge plate directly (e.g., sensing position of the gauge plate itself) or may sense the position of the gauge plate indirectly (e.g., sensing position of some part of the indexing assembly that effects movement of the gauge plate). As previously indicated, the sensor could also be an integrated part of the drive motor (e.g., an encoder that outputs counts or steps corresponding to drive motor rotation, with the controller tracking the step count away from the known zero position of the gauge plate).

Although a rotatable knob is described above for use in manual adjustment of the gauge plate position, it is recognized that the knob could be eliminated and, for example, buttons (e.g., physical buttons 130 or button images presented on a touch-screen display 110) could be used by an operator to open and close the gauge plate.

In embodiments, the controller 100 could be configured with advanced functionality, such as an auto-close feature by which the controller automatically causes the gauge plate to close upon a predefined condition (e.g., after a set time period of no slicing or after a programmed slice operation has completed). For example, the controller could be configured to close the gauge plate after a certain number of slices have been cut or after a certain weight of slices has been cut (where the slicer includes a load cell 132 for weighing the sliced product).

Still other variations are possible.

1. A food product slicer, comprising:
a base;
a knife mounted for rotation relative to the base;
a carriage assembly mounted to the base for reciprocal movement back and forth past a cutting edge of the knife;
an adjustable gauge plate mounted for movement between a closed position that prevents slicing and multiple open positions that permit slicing at respective thicknesses;
a slice thickness identification system including:
at least one sensor for determining a position of the gauge plate; and
a display for displaying a slice thickness indicator corresponding to the determined position.

2. The food product slicer of claim 1, wherein the at least one sensor comprises a capacitive array sensor.

3. The food product slicer of claim 1, wherein the at least one sensor comprises at least one of an encoder, a potentiometer, a potentiometer, and infrared distance sensor, or an imaging system sensor.

4. The food product slicer of claim 1, wherein the at least one sensor comprises an encoder that is incorporated into a motor that is linked to move the gauge plate.

5. The food product slicer of claim 1, further comprising a controller that is configured to identify slice thickness based upon output from the at least one sensor.

6. The food product slicer of claim 5, further comprising a motor linked to move the gauge plate, wherein the controller is configured to (i) store at least one predetermined slice thickness that is selectable by an operator and (ii) automatically drive the motor to move the gauge plate to achieve the predetermined slice thickness.

7. The food product slicer of claim 1, wherein the controller is configured with an auto-close function by which the controller automatically drives the motor to cause the gauge plate to move to the closed position responsive to a predefined condition.

8. The food product slicer of claim 1, further comprising:
a gauge plate drive system including a motor operatively linked for adjusting the gauge plate position and a controller configured to drive the motor responsive to operator selection of a thickness.

9. The food product slicer of claim 8, further comprising:
at least one of a touch-screen interface or a knob for enabling operator selection of the thickness.

10. A food product slicer, comprising:
a base;
a knife mounted for rotation relative to the base;
a carriage assembly mounted to the base for reciprocal movement back and forth past a cutting edge of the knife;
an adjustable gauge plate mounted for movement between a closed position that prevents slicing and multiple open positions that permit slicing at respective thicknesses;
a gauge plate drive system including a motor operatively linked for adjusting the gauge plate position and a controller configured to drive the motor responsive to operator selection of a thickness.

11. The food product slicer of claim 10, further comprising a knob operably connected to the gauge plate drive system.

12. The food product slicer of claim 11, wherein the gauge plate position is adjusted by either (i) manual rotation of the knob by an operator or (ii) the controller effective driving of the motor.

13. The food product slicer of claim 10, wherein the gauge plate drive system further comprises one or more actuatable physical buttons or the controller configured to present on a touch-screen display one or more actuatable buttons.

14. The food product slicer of claim 10, wherein the controller is configured to (i) store multiple predetermined slice thicknesses that are selectable by an operator and (ii) automatically drive the motor to move the gauge plate to achieve the predetermined slice thickness that is selected by the operator.

15. The food product slicer of claim 14, wherein one of the multiple predetermined slice thicknesses is a first section thickness.

16. The food product slicer of claim 15, wherein the controller is configured to drive the motor to move the gauge plate to achieve the first section thickness for a first slice and then drive the motor to move the gauge plate to achieve another predetermined slice thickness for subsequent slices.

17. The food product slicer of claim 10, wherein the controller is configured with an auto-close function by which the controller automatically causes the gauge plate to move to the closed position responsive to a predefined condition.

18. The food product slicer of claim 10, wherein the controller is configured with a slice thickness adjust feature by which the controller automatically adjusts gauge plate position during slicing to achieve a target slice weight.

19. The food product slicer of claim 18, wherein the target slice weight is a target weight range for each slice.
